(19) United States
(12) Patent Application Publication
(10) Pub. No.: US 2005/0159192 A1
(43) Pub. Date: Jul. 21, 2005

(54) Control device

(76) Inventor: T. Michael Abinanti, Palatine, IL (US)

Correspondence Address: PAULEY PETERSEN & ERICKSON, 2800 WEST HIGGINS ROAD, SUITE 365, HOFFMAN ESTATES, IL, 60195, US

(21) Appl. No.: 10/762,644

(22) Filed: Jan. 20, 2004

(51) Int. Cl. H04M 1/00

(52) U.S. Cl. 455/575.1

(57) ABSTRACT

A control device including a transmitter module mounted with respect to a piece of equipment and a remote receiver device in responsive communication with the transmitter module. The remote receiver device receives at least one control signal transmitted from the transmitter module and transfers the control signal into an electrical action and/or a mechanical action. The control device can include a sleeve removably fastened about a gunstock, wherein the transmitter module is mounted within a pocket formed by the sleeve.

### BACKGROUND OF THE INVENTION

1. Field of the Invention

This invention relates generally to a control device and, more particularly, to a control device having a transmitter module mountable with respect to a piece of equipment, such as a gunstock portion of a firearm, and a remote receiver device in responsive communication with the transmitter module.

2. Discussion of Related Art

Many conventional control devices, such as pet training devices, include a wireless handheld command module and a wireless receiver module, which can be attached to a collar positioned about the animal's neck. A stimulation command is transmitted from the handheld command module to the receiver module during training procedures to emit a weak shock or vibration signal from the receiver module. Using such conventional control devices, a dog can be trained to refrain from barking at people by transmitting a stimulation command, which the dog receives via the receiver module positioned about its neck Such stimulation training discourages the dog from further undesirable behavior, such as barking. Such conventional control devices can also be used by a hunter operator to communicate with a hunting dog while in the field. However, during use the hunter operator must remove his or her hand from the hunting equipment, such as a rifle for example, in order to transmit a stimulation command from the handheld command module to the receiver module, which can be undesirable and/or dangerous.

There is an apparent need for a control device including a transmitter module in operational control communication with a remote receiver device that can be mounted with respect to a piece of equipment, such as a firearm gunstock, to allow the user to operate the control device without requiring a separate handheld transmitter module. Thus, the user can operate the control device without removing his or her hand from the equipment piece.

### SUMMARY OF THE INVENTION

One object of this invention is to provide an improved control device.

Another object of this invention is to provide a control device having a transmitter module that is mountable with respect to the equipment piece to allow the user to operate the control device without removing the user's hand from the equipment piece.

The above and other objects of this invention can be attained through a control device including a transmitter module mounted with respect to a piece of equipment. The transmitter module can be removably mounted or fastened to the equipment piece, integrated with the equipment piece or detachably mounted or connected to the equipment piece.

The transmitter module preferably includes at least one control contact, such as a pushbutton, for transmitting a dedicated control signal to a remote receiver device. The remote receiver device is in responsive communication with the transmitter module, and receives one or more control signals transmitted from the transmitter module. The dedicated control signal may be a voice signal, a sound signal, a single shock signal, a multiple shock signal, a single vibration signal and/or a multiple vibration signal, for example. In one preferred embodiment of this invention, the remote receiver device is positioned on or within an animal training collar and transfers or translates the control signal into at least one of an electrical and a mechanical action corresponding to the selected control signal.

A control device with a transmitter module mounted with respect to the equipment piece allows the user to operate the control device without having to release or remove the user's hand from the equipment piece.

In one preferred embodiment of this invention, a sleeve is removably fastened to the equipment piece, for example about a firearm gunstock. Preferably, the sleeve is fastened to the gunstock using at least one of a snap, a button, a hook-and-loop fastener, a strap fastener, a zipper arrangement and any other suitable fastener. The transmitter module may be secured to the sleeve or mounted within a pocket formed by the sleeve. The remote receiver device, in responsive communication with the transmitter module, receives one or more control signals transmitted from the transmitter module. The remote receiver device preferably is positioned within an animal training collar, and receives at least one control signal transmitted from the transmitter module. The remote receiver device translates each control signal into an electrical action and/or a mechanical action.

In one preferred embodiment of this invention, the transmitter module further includes a control panel in operation control communication with the remote receiver device. The control panel has a plurality of pushbuttons, each pushbutton corresponding to one or more dedicated control signals. For example, a first pushbutton can operate a sound signal, a second pushbutton can operate a single shock signal and a third pushbutton can operate a multiple shock signal.

Other objects and advantages of this invention are apparent to those skilled in the art, in view of the following detailed description taken in conjunction with the appended claims and drawings.

### BRIEF DESCRIPTION OF THE DRAWINGS

FIG. 1 is a side view of a rifle with a control device transmitter module mounted with respect to a gunstock of the rifle, according to one preferred embodiment of this invention;

FIG. 2 is a side view of a control device transmitter module integrated with a rifle gunstock, according to one preferred embodiment of this invention;

FIG. 3 is a side view of a control device transmitter module positioned within a sleeve removably fastened about a rifle gunstock, according to one preferred embodiment of this invention;

FIG. 4 is a side view of a control device transmitter module detachably connected to a rifle gunstock, according to one preferred embodiment of this invention; and

FIG. 5 is a perspective view of a control device remote receiver device, according to one preferred embodiment of this invention.

### DETAILED DESCRIPTION OF INVENTION

This invention provides a control device 20 mountable with respect to a piece of equipment. In one preferred embodiment of this invention, control device 20 can be used as an electronic transmitter module 30 for transmitting electronic or frequency signals to a remote receiver device 50 positioned on or within a training device, such as a collar worn by a dog. In one preferred embodiment of this invention, control device 20 operates a dog training collar that is used to train dogs, including hunting dogs.

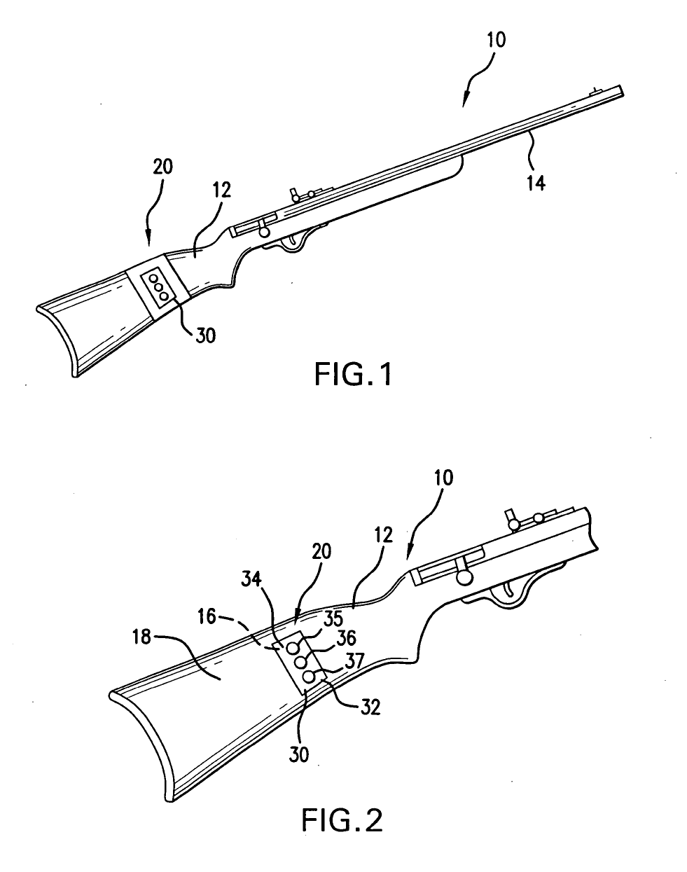

Referring to FIGS. 1-4, control device 20 comprises a transmitter module 30 mounted with respect to a piece of equipment, such as sporting equipment. With transmitter module 30 mounted with respect to the equipment piece, the user does not have to release or remove his or her hand from the equipment piece to operate transmitter module 30. It is apparent to those skilled in the art that the control device of this invention can be used in cooperation with any suitable sporting equipment. For example, as shown in FIG. 1, control device 20 can be used in cooperation with a firearm, such as a rifle 10 having a gunstock 12 attached with respect to a barrel 14.

Preferably, transmitter module 30 is mounted, attached or connected to rifle 10 at or near gunstock 12. In one preferred embodiment of this invention, transmitter module 30 is integrated with gunstock 12. For example, as shown in FIG. 2, transmitter module 30 can be positioned and secured or locked within a cavity 16 formed in gunstock 12. With transmitter module 30 secured or locked within cavity 16 and mounted with respect to gunstock 12, a faceplate 32 of transmitter module 30 is relatively flush with an outer surface 18 of gunstock 12. The integrated mounting of transmitter module 30 eliminates the need for the user to carry a separate handheld transmitter module.

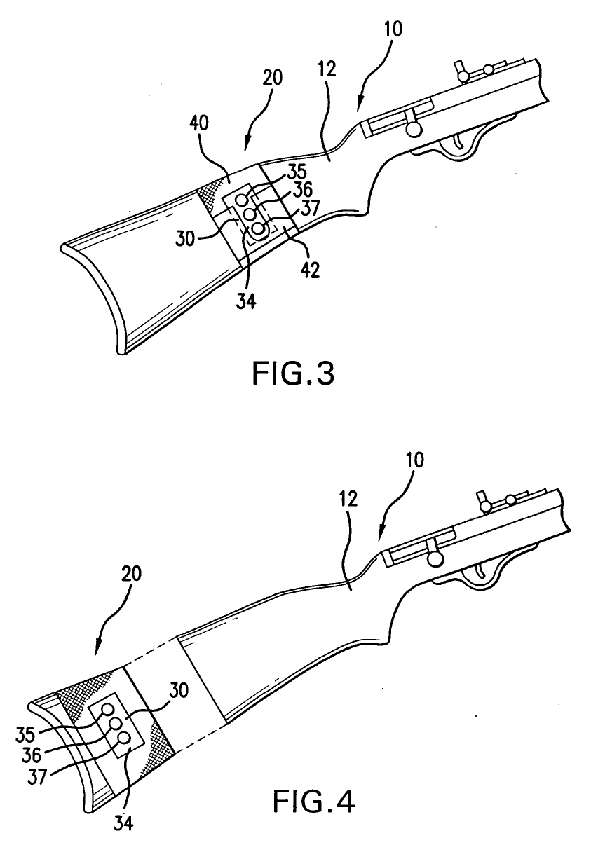

In one preferred embodiment of this invention, transmitter module 30 is detachably mounted with respect to gunstock 12 or another similar equipment piece. As used throughout this specification and in the claims, the phrase detachably mounted is intended to relate to transmitter module 30 being removably fastened, mounted, fixed and/or connected, directly or indirectly, to gunstock 12. Preferably, transmitter module 30 is positionable on or within a bracket, jacket or sleeve 40 removably fastened to gunstock 12. In one preferred embodiment of this invention, transmitter module 30 is attached to or within sleeve 40 using any suitable fastening means, such as stitching, a snap, a button, a hook-and-loop fastener, a strap fastener, a zipper arrangement and/or any other suitable fastener. As shown in FIG. 3, according to another embodiment, transmitter module 30 can be attached to, inserted or positioned within a pocket 42 formed on or in sleeve 40.

Sleeve 40 is preferably made of a flexible and/or stretchable material so that sleeve 40 can be easily positioned about gunstock 12. For example, sleeve 40 may comprise a LYCRA or SPANDEX material, a nylon material, a leather material, a plastic material and/or any other suitable natural or synthetic material. Further, sleeve 40 can be removably fastened about gunstock 12 using any suitable fastener, such as a snap, a button, a hook-and-loop fastener, a strap fastener and/or a zipper arrangement. Other suitable fasteners known to those skilled in the art can be used to removably fasten sleeve 40 to gunstock 12. Preferably but not necessarily, sleeve 40 is fastened about gunstock 12 at a bottom portion of gunstock 12, rather than at a side portion or top portion of gunstock 12 so that sleeve 40 does not interfere with the use of rifle 10.

Cavity 16 and/or sleeve 40 is preferably interchangeably designed so that transmitter module 30 can be positioned on either side portion of gunstock 12, depending upon whether the user is right hand dominant or left hand dominant.

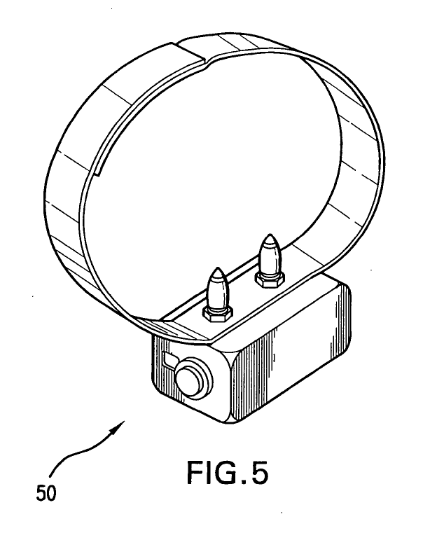

In one preferred embodiment of this invention, transmitter module 30 is detachably mounted to the equipment piece. For example, as shown in FIG. 4, transmitter module 30 can be detachably mounted or connected with respect to gunstock 12 using any suitable mechanical connector or fastener, including adhesive and/or hook-and-loop fasteners or connectors. Preferably, but not necessarily, when detachably mounted or connected to gunstock 12, a profile of transmitter module 30 corresponds to or is relatively flush with a profile of gunstock 12, as shown in FIG. 4.

Referring to FIG. 5, control device 20 further comprises a remote receiver device 50 in responsive communication with transmitter module 30. Remote receiver device 50 receives one or more control signals transmitted from the transmitter module 30 and transfers or translates the control signal into at least one of an electrical and a mechanical action. In one preferred embodiment of this invention, remote receiver device 50 is positioned on or within an animal training collar, and receives at least one selected control signal transmitted by the transmitter module 30. For example, in response to the received control signal, remote receiver device 50 translates the received signal into an electrical and/or mechanical action, whereby the animal wearing the training collar can be trained to respond to the control signal in an appropriate manner. For example, while hunting fowl, the user can signal the hunting dog when the dog positions itself too far from the user in the field or when the user wishes to survey the field in a selected direction. Activating transmitter module 30 to transmit a dedicated control signal to remote receiver device 50 is intended to elicit a responsive action from the hunting dog, as desired by the user.

Preferably, transmitter module 30 comprises a control panel 34, including a microprocessor, a microcontroller and/or an electronic circuit board, in operational control communication with remote receiver device 50. Any suitable computer, microcomputer, microprocessor, microcontroller and/or electronic circuit board known to those skilled in the can be used to provide wireless communication between transmitter module 30 and remote receiver device 50 and process or translate any transmitted control signal. In one preferred embodiment of this invention, transmitter module 30 comprises a microcontroller in operational control communication with remote receiver device 50. As shown in FIGS. 2-4, transmitter module control panel 34 comprises at least one control contact, such as a pushbutton or other suitable electrical contact to correspond to and/or operate dedicated control functions of transmitter module 30. For example, as shown in FIGS. 2-4, transmitter module control panel 34 comprises three pushbuttons 35, 36, 37. Each pushbutton transmits a programmable or selectable dedicated control signal to remote receiver device 50. In one preferred embodiment of this invention where transmitter module 30 is an electronic remote controller for a dog training collar, a first pushbutton 35 can operate a sound signal, including a voice recognition signal or recorded sound signal, a second pushbutton 36 can operate a single shock signal and/or single vibration signal, and a third pushbutton 37 can operate a multiple shock signal and/or multiple vibration signal. More or less pushbuttons can be used, depending upon the desired control result. Any signal transmitted by transmitter module 30 can be received at remote receiver device 50, for example at the dog training collar which can then transfer or translate the dedicated signal into an electrical and/or mechanical action. The electrical and/or mechanical action may include a shock, a vibration and/or a sound, for example.

Thus, this invention provides a control device that comprises a transmitter module mountable with respect to an equipment piece and in operational control communication with a remote receiver device. In certain preferred embodiments of this invention, the transmitter module can be integrated with the equipment piece, removably fastened to or about the equipment piece or detachably connected or mounted to the equipment piece. The transmitter module comprises a control panel having at least one control contact, such as a pushbutton, for transmitting at least one dedicated control signal to the remote receiver device. The remote receiver device can be positioned within a dog training collar, for example, to receive at least one selected control signal transmitted by the transmitter module and in response to the received control signal transfer or translate the received signal into an electrical and/or mechanical action.

This invention illustratively disclosed suitably may be practiced in the absence of any element, part, step, component, or ingredient which is not specifically disclosed in this specification, in the claims and/or in the drawings.

While in the foregoing detailed description this invention has been described in relation to certain preferred embodiments thereof, and many details have been set forth for purposes of illustration, it will be apparent to those skilled in the art that this invention is susceptible to additional embodiments and that certain of the details described can be varied considerably without departing from the basic principles of this invention.

1. A control device comprising:
a transmitter module one of detachably mounted to and integrated with a sporting equipment.

2. The control device of claim 1 further comprising a remote receiver device in responsive communication with the transmitter module, and the remote receiver device receiving at least one control signal transmitted from the transmitter module.

3. The control device of claim 1 wherein the sporting equipment comprises a firearm.

4. The control device of claim 1 wherein the transmitter module is positioned within a sleeve removably fastened to the sporting equipment.

5. The control device of claim 1 wherein the transmitter module is integrated with the sporting equipment.

6. The control device of claim 5 wherein a faceplate of the transmitter module is generally flush with an outer surface of the sporting equipment.

7. The control device of claim 1 wherein the transmitter module further comprises a microcontroller in operational control communication with a remote receiver device.

8. The control device of claim 7 wherein the microcontroller further comprises an electronic circuit board.

9. The control device of claim 1 wherein the transmitter module further comprises at least one control contact.

10. The control device of claim 9 wherein the at least one control contact comprises a pushbutton for transmitting a dedicated control signal to a remote receiver device.

11. A control device comprising:
a sleeve removably fastened to a gunstock, and the sleeve holding a transmitter module.

12. The control device of claim 11 further comprising a remote receiver device in responsive communication with the transmitter module, and the remote receiver device receiving at least one control signal transmitted from the transmitter module.

13. The control device of claim 11 wherein at least one of a snap, a button, a hook-and-loop fastener, a strap fastener and a zipper fastens the sleeve to the gunstock.

14. The control device of claim 1 1 wherein the transmitter module further comprises a microcontroller in operational control communication with a remote receiver device.

15. The control device of claim 1 1 wherein the transmitter module further comprises at least one control contact.

16. The control device of claim 15 wherein the at least one control contact comprises a pushbutton for transmitting a dedicated control signal to a remote receiver device.

17. The control device of claim 16 wherein the dedicated control signal comprises at least one of a voice signal, a sound signal, a single shock signal, a multiple shock signal, a single vibration signal and a multiple vibration signal.

18. The control device of claim 11 wherein a remote receiver device translates the control signal into at least one of an electrical action and a mechanical action.

19. A control device comprising:
a transmitter module mounted with respect to a piece of equipment.

20. The control device of claim 19 further comprising a remote receiver device in responsive communication with the transmitter module, the remote receiver device receiving at least one control signal transmitted from the transmitter module and translating the control signal into at least one of an electrical action and a mechanical action.

21. The control device of claim 19 wherein the transmitter module further comprises a control panel in operational control communication with a remote receiver device, the control panel comprising a plurality of pushbuttons, each pushbutton of the plurality of pushbuttons corresponding with a dedicated control signal.

22. The control device of claim 19 wherein a first pushbutton of the plurality of pushbuttons operates a sound signal, a second pushbutton of the plurality of pushbuttons operates at least one of a single shock signal and a single vibration signal and a third pushbutton of the plurality of pushbuttons operates at least one of a multiple shock signal and a multiple vibration signal.
